(19) United States
(12) Patent Application Publication
(10) Pub. No.: US 2025/0007438 A1
(43) Pub. Date: Jan. 2, 2025

(54) MOTOR DRIVE SYSTEM AND NON-TRANSITORY COMPUTER READABLE STORAGE MEDIUM

(71) Applicant: DENSO CORPORATION, Kariya-city (JP)

(72) Inventors: Yoshihiro NAKASHIMA, Kariya-city (JP); Toshihiro YAMAMOTO, Kariya-city (JP)

(21) Appl. No.: 18/882,282

(22) Filed: Sep. 11, 2024

Related U.S. Application Data
(63) Continuation of application No. PCT/JP2023/007864, filed on Mar. 2, 2023.

(30) Foreign Application Priority Data
Mar. 16, 2022 (JP) 2022-041703

(51) Int. Cl. H02P 27/06

(52) U.S. Cl. CPC H02P 27/06

(57) ABSTRACT

A motor drive system includes a DC power supply, a motor, a drive circuit and a controller. The drive circuit includes a converter, an inverter, and a smoothing capacitor. The converter has a resonance circuit that resonates in a predetermined resonance frequency band. The converter converts a voltage of the DC power supply. The inverter executes power conversion between the converter and the motor. The smoothing capacitor is connected between the converter and the inverter in parallel. The controller controls the drive circuit to suppress a capacitor current flowing to the smoothing capacitor by controlling a supply current being supplied from the converter to the smoothing capacitor and the inverter, according to fluctuation in a load current flowing to the inverter.

### CROSS REFERENCE TO RELATED APPLICATIONS

The present application is a continuation application of International Patent Application No. PCT/JP2023/007864 filed on Mar. 2, 2023, which designated the U.S. and claims the benefit of priority from Japanese Patent Application No. 2022-041703 filed on Mar. 16, 2022. The entire disclosures of all of the above applications are incorporated herein by reference.

### TECHNICAL FIELD

The present disclosure relates to a drive system that drives a motor.

### BACKGROUND

A motor drive system may include a drive circuit having a converter and an inverter. The converter may have a resonant circuit that resonates in a predetermined resonant frequency band, and may convert a voltage of a direct current (DC) power supply. The inverter may execute power conversion between the converter and a motor.

### SUMMARY

The present disclosure describes a motor drive system including a motor, a drive circuit and a controller.

### BRIEF DESCRIPTION OF DRAWINGS

Objects, features and advantages of the present disclosure will become more apparent from the following detailed description made with reference to the accompanying drawings. In the drawings:

FIG. 1 is an electric circuit diagram of a motor drive system;

FIG. 2 illustrates control modes of an inverter;

FIG. 3 is a graph showing a voltage, a supply current, a load current, and a capacitor current when resonance occurs in a comparative example;

FIG. 4 is a schematic diagram showing the relationship of respective currents in blocks of the motor drive system related to the comparative example;

FIG. 5 is a schematic diagram that illustrates suppression of a capacitor current;

FIG. 6 is a block diagram that illustrates suppression of the capacitor current;

FIG. 7 is a flowchart showing a procedure of booster control;

FIG. 8 is a graph showing the relationship among the rotation speed of a motor, the battery current, and the voltage in the comparative example;

FIG. 9 is a graph showing the relationship among the rotation speed of the motor, the battery current, and the voltage;

FIG. 10 is a partial block diagram showing a modified example of the configuration for extracting the fluctuation of the load current;

FIG. 11 is a partial block diagram showing a modified example of booster control; and

FIG. 12 is a graph showing an overview of a 60-degree moving average.

### DETAILED DESCRIPTION

In a case where a motor rotation speed is included in a band where resonance occurs in a drive circuit of a motor drive system when a converter of the motor drive system does not convert voltage, if the amount of heat generation in a DC power supply is larger than or equal to a threshold value, the motor drive system does not allow square wave control that generates a square wave voltage with a period corresponding to the motor rotation speed, but switches to pulse-width-modulation (PWM) control that operates the inverter with a control period that is independent of the motor rotation speed. According to the drive system described above, the amount of heat generated by the DC power supply is monitored. If the amount of heat generation is larger than or equal to a threshold value, the square wave control is restricted. Therefore, it is possible to appropriately suppress overheating of the DC power supply caused by the resonance of the drive circuit.

Although the motor drive system described above can prevent overheating of the DC power supply caused by the resonance in the drive circuit, it cannot prevent resonance itself from occurring in the drive circuit. For this reason, in the motor drive system described above, it is necessary to switch from the square wave control to the PWM control in a case where the motor rotation speed is included in a band where the resonance occurs in the drive circuit so that a decrease in motor output cannot be avoided.

According to a first aspect of the present disclosure, a motor drive system includes a DC power supply, a motor, a drive circuit and a controller. The drive circuit includes a converter, an inverter and a smoothing capacitor. The converter has a resonance circuit resonating at a predetermined resonance frequency band. The converter executes power conversion between the converter and the motor. The smoothing capacitor is connected between the converter and the inverter in parallel. The controller controls the drive circuit to suppress a capacitor current flowing to the smoothing capacitor by controlling a supply current supplied from the converter to the smoothing capacitor and the inverter according to fluctuation of a load current flowing to the inverter.

According to the above configuration, the drive circuit includes the converter, the inverter and the smoothing capacitor. The converter has the resonance circuit resonating at a predetermined resonance frequency band. The converter executes power conversion between the converter and the motor. Therefore, there is a possibility of interference and resonance of voltage and current occurring within the drive circuit due to the interaction between the supply current supplied from the converter to the smoothing capacitor and the inverter, and the load current flowing into the inverter. Fluctuation in the load current caused by the resonance characteristics of the motor may act as a trigger for the resonance generation, and thus cause interference between the supply current and the load current and lead to fluctuation in the voltage of the smoothing capacitor.

The applicant of the present application noticed that the voltage fluctuation in the smoothing capacitor due to the resonance. In addition, the capacitor current is a current acquired by subtracting the load current from the supply current. For this reason, if the capacitor current is suppressed by adjusting the capacitor current closer to zero, it is possible to suppress the voltage fluctuation in the smoothing capacitor due to the resonance. The controller controls the supply current according to the fluctuation in the load current in order to suppress the capacitor current. Thus, it is possible to suppress the voltage fluctuation in the smoothing capacitor due to the resonance, and it is possible to suppress generation of the resonance in the drive circuit of the motor drive system.

According to a second aspect of the present disclosure, the controller includes a load current estimation unit that estimates the load current based on a driving state of the motor. According to such a configuration, it is possible that the load current estimation unit estimates the load current from the driving state of the motor monitored by the controller. Thus, there is no need to have an additional new component such as a current sensor to detect the load current.

According to a third aspect of the present disclosure, the controller includes a fluctuation extraction unit that extracts the fluctuation of the load current from the load current being estimated by the load current estimation unit.

When the load current has a harmonic component, the supply current controlled according to the fluctuation in the load current is also affected by the harmonic component. As a result, a pulsating component such as a ripple included in the supply current may increase.

According to a fourth aspect of the present disclosure, the controller includes a component removal unit that receives the harmonic component from the load current being estimated by the load current estimation unit. According to such a configuration, it is possible to remove the harmonic component from the load current, and it is possible to suppress an increase in the ripple of the supply current.

According to a fifth aspect of the present disclosure, the controller controls the drive circuit to suppress the capacitor flowing to the smoothing capacitor by controlling magnitude of the supply current to be closer to magnitude of the load current. According to such a configuration, it is possible to suppress the capacitor current flowing to the smoothing capacitor by controlling the magnitude of the supply current.

According to a sixth aspect of the present disclosure, the controller controls the drive circuit to suppress the capacitor flowing to the smoothing capacitor by synchronizing a first phase of the motor with a second phase of the motor. The first phase is a phase in which the supply current fluctuates, and the second phase is a phase in which the load current fluctuates. According to such a configuration, it is possible to suppress the capacitor current flowing to the smoothing capacitor by controlling the first phase in which the supply current fluctuates.

According to a seventh aspect of the present disclosure, a non-transitory computer readable medium stores a computer program adapted to a motor drive system including a DC power supply, a motor, a drive circuit and a controller. The drive circuit includes a converter, an inverter and a smoothing capacitor. The converter has a resonance circuit resonating at a predetermined resonance frequency band. The converter executes power conversion between the converter and the motor. The smoothing capacitor is connected between the converter and the inverter in parallel. The controller drives the drive circuit. The computer program includes instructions, when executed by the controller, cause the controller to suppress a capacitor current flowing to the smoothing capacitor by controlling a supply current being supplied from the converter to the capacitor and the inverter according to fluctuation of a load current flowing to the inverter.

According to the above-mentioned configuration, it is possible that the non-transitory computer readable medium exhibits an advantageous effect similar to the first aspect described above.

The following describes an embodiment related to a motor drive system for driving a motor of an electric moveable object with reference to the drawings. In the following description, the same components are denoted by the same reference numerals, and their names and functions are the same. The electric movable object may be, for example, an electric vehicle, an electric aircraft, and an electric ship.

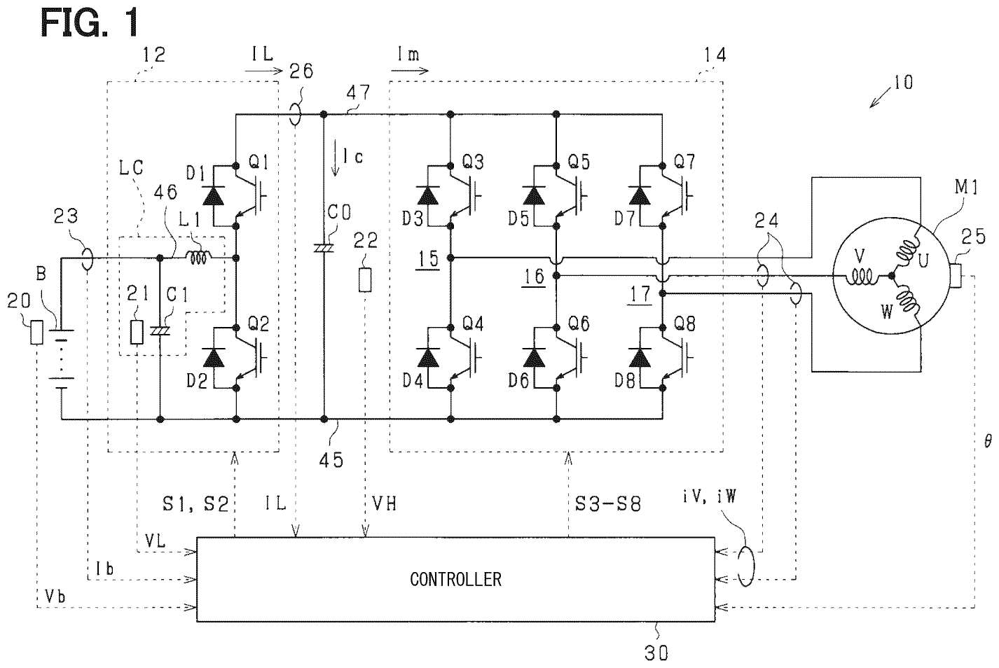

As shown in FIG. 1, the motor drive system 10 includes a DC power supply B, a converter 12, a smoothing capacitor C0, an inverter 14, a motor M1, and a controller 30.

For example, the motor M1 generates torque for driving the drive wheels of an electric vehicle. Alternatively, the motor M1 may have the function of a generator driven by the engine, or may have both the functions of an electric motor and a generator. Furthermore, the motor M1 may operate as a starter and an electric motor for an engine and may be incorporated in a hybrid vehicle.

The DC power supply B includes a secondary battery such as a nickel-metal hydride battery or a lithium ion battery.

The converter 12 is connected to a DC power supply B via a positive line 46 and a negative line 45. The converter 12 includes a smoothing capacitor C1, a reactor L1, switching elements Q1 and Q2 being power semiconductors, and diodes D1 and D2. The positive line 46 may also be referred to as a positive electrode line, and the negative line 45 may also be referred to as a negative electrode line.

The smoothing capacitor C1 is connected between the positive electrode line 46 and the negative line 45, and smoothens out voltage fluctuation between the positive line 46 and the negative line 45. In the present disclosure, the terms “voltage fluctuation” and “current fluctuation” may also be referred to as “voltage variation” and “current variation”, respectively.

The switching elements Q1 and Q2 are connected in series between the positive line 47 and the negative line 45. It is possible to adopt, for example, an insulated gate bipolar transistor (IGBT), a power metal-oxide-semiconductor (MOS) transistor, and a power bipolar transistor as a switching element. The diodes D1 and D2 are connected in parallel to the switching elements Q1 and Q2, respectively.

The reactor L1 is connected between the positive line 46 and a connection node that is located between the switching elements Q1 and Q2.

The converter 12 executes voltage conversion between the DC power supply B and the inverter 14 by controlling the opening and closing of the switching elements Q1, Q2 in response to control signals S1, S2 from the controller 30. During the booster operation of the converter 12, the power supply voltage Vb (DC voltage) supplied from the DC power supply B is boosted by the converter 12 and supplied to the inverter 14. During the reduction operation of the converter 12, the voltage supplied from the inverter 14 is reduced by the converter 12 and supplied to the DC power supply B. During the voltage conversion (the booster operation or the reduction operation) of the converter 12, the switching elements Q1 and Q2 are repeatedly opened and closed in a complementary manner. The booster operation may also be referred to as a step-up operation, and the reduction operation may also be referred to as a step-down operation.

On the other hand, when the converter 12 is not converting voltage, the switching element Q1 (upper arm) is maintained in a closed state; and the switching element Q2 (lower arm) is maintained in an open state. When the converter 12 is not converting voltage, the power supply voltage Vb supplied from DC power supply B is supplied to the inverter 14 as is without being converted.

The smoothing capacitor C0 is connected between the positive line 47 and the negative line 45, and smoothens out voltage fluctuation between the positive line 47 and the negative line 45. The smoothing capacitor C0 is connected between the converter 12 and the inverter 14 in parallel.

The inverter 14 is connected to the converter 12 via the positive line 47 and the negative line 45. The inverter 14 includes a U-phase arm 15, a V-phase arm 16, and a W-phase arm 17 that are provided in parallel with each other between the positive line 47 and the negative line 45. Each phase arm includes a switching element connected in series between the positive line 47 and the negative line 45. That is, the U-phase arm 15 includes the switching elements Q3 and Q4. The V-phase arm 16 includes the switching elements Q5 and Q6. The W-phase arm 17 includes the switching elements Q7 and Q8. The diodes D1 to D6 are connected in parallel to switching elements Q1 to Q6, respectively.

The intermediate node of each phase arm is connected to a corresponding phase end of the corresponding phase coil of the motor M1. The motor M1 is a three-phase permanent magnet motor, and is configured such that one ends of three coils of U, V, and W phases are commonly connected to a neutral point. Furthermore, the other end of each phase coil is connected to the intermediate node of the switching element of each of the phase arms 15 to 17.

The inverter 14 executes power conversion between the converter 12 and the motor M1 by controlling the opening and closing of the switching elements Q3 to Q8 in response to control signals S3 to S8 from the controller 30. When the motor M1 functions as an electric motor, the inverter 14 converts the DC power from the converter 12 into alternating current (AC) power and supplies the AC power to the motor M1. For example, during regenerative braking of the electric vehicle (when the motor M1 is made to function as a generator), the inverter 14 converts the regenerative power generated by the motor M1 into DC power and supplies the DC power to the converter 12.

The motor drive system 10 includes voltage sensors 20 to 22, current sensors 23, 24, 26, and a resolver 25. The voltage sensor 20 detects the power supply voltage Vb output by the DC power supply B. The voltage sensor 21 detects the voltage across the smoothing capacitor C1 (hereinafter also referred to as voltage VL). The voltage sensor 22 detects the voltage across the smoothing capacitor C0 (hereinafter also referred to as voltage VH). The current sensor 23 detects a current Ib flowing through the DC power supply B. The current sensor 24 detects the current flowing through the motor M1. The current sensor 26 detects the supply current IL supplied from the converter 12 to the smoothing capacitor C0 and the inverter 14. In addition, since the sum of the instantaneous values of the three-phase currents iu, iv, iw is zero, it is sufficient that the current sensor 24 is arranged to detect motor currents for two phases (for example, the V-phase current iv and the W-phase current iw) as shown in FIG. 1. The resolver 25 detects the rotor rotation angle θ and the rotation speed N of the motor M1. These sensors output the detection result to the controller 30. The voltage VH corresponds to a capacitor voltage.

The controller 30 includes an electronic control unit (ECU) having, for example, a built-in CPU (Central Processing Unit) and memory (not shown), and executes predetermined calculation processing based on maps and programs stored in the memory. The predetermined calculation processing may also be referred to as predetermined arithmetic processing.

The controller 30 executes voltage conversion (booster operation or reduction operation) between the voltage VL and the voltage VH by complementarily opening and closing the switching element Q1 (upper arm) and the switching element Q2 (lower arm) of the converter 12 in response to, for example, a user's request.

The controller 30 switches among three control modes for the voltage conversion in the inverter 14. The three control modes are sine wave PWM control, overmodulation PWM control, and square wave control. The controller 30 controls the drive circuit of the motor M1.

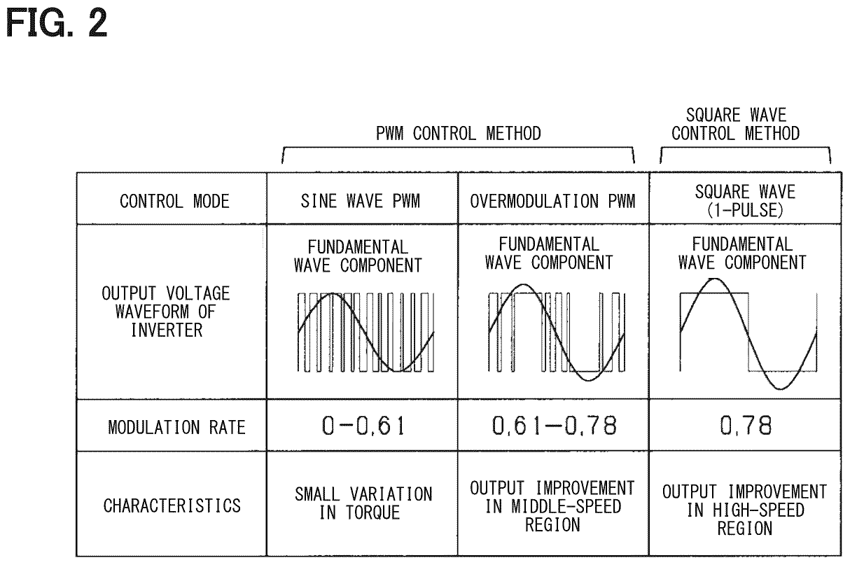

FIG. 2 illustrates the control modes (control methods) of the inverter 14. The numerical values of the modulation rates explained in FIG. 2 are merely examples and are not limited.

As described above, the three control modes for the inverter 14 are the sine wave PWM control, the overmodulation PWM control, and the square wave control.

The sine wave PWM control is a commonly used PWM control method, in which the opening and closing of switching elements in each phase arm is controlled based on a voltage comparison between a sinusoidal voltage command value and a carrier wave (carrier signal). As a result, the fundamental wave component of the inverter output voltage becomes a pseudo sine wave within a certain period of time. In the sine wave PWM control, the amplitude of this fundamental wave component can only be increased to 0.61 times the inverter input voltage (the modulation rate can only be increased to 0.61).

The overmodulation PWM control involves distorting the carrier wave so as to reduce its amplitude, and then carrying out PWM control similar to the sine wave PWM control described above. As a result, the modulation rate can be increased to the range of 0.61 to 0.78. In this embodiment, both the sine wave PWM control and the overmodulation PWM control are collectively classified as a “PWM control method.” In the PWM control method, the control period (switching period) of the inverter 14 usually depends on the frequency of the carrier wave (carrier frequency) and does not depend on the motor rotation speed N.

In the square wave control, a square wave voltage of one pulse is applied to the motor M1 by executing a single switching operation per output period (one period of electrical angle) of the rotor rotation angle θ. In the square wave control, the inverter 14 operates at a control period that depends on the motor rotation speed N. As a result, while the square wave control may be lower in control precision (control responsiveness) as compared with the PWM control, it is possible to increase the modulation rate up to 0.78 and thus increase motor output.

Taking into consideration the differences in the characteristics of these control methods, under normal circumstances, the controller 30 selects the PWM control method when the motor operating point determined by the motor torque T and motor rotation speed N (either of which may be a target value or an actual value) is on the lower side (low torque, low rotation side) of a predetermined inverter control boundary line, and selects the square wave control method when the motor operating point is on the higher side (high torque, high rotation side) of the inverter control boundary line.

In the motor drive system 10 having the above-mentioned configuration, the converter 12 includes a reactor L1 and a smoothing capacitor C1. The converter 12 is included in a part of a drive circuit of the motor M1. The reactor L1 includes an inductance component that may also be referred to as an L-component. The smoothing capacitor C1 includes a capacitance component that may also be referred to as a C-component.

On the other hand, in the square wave control method as one of the control methods for the inverter 14, the inverter 14 operates at a control period that depends on the motor rotation speed N as described above. Fluctuation in the load current Im due to the resonance characteristics of the motor M1 triggers the occurrence of resonance, and the supply current IL and the load current Im interfere with each other to cause the fluctuation in the voltage VH of the smoothing capacitor C0. Furthermore, an error (disturbance) in the current sensor 24 may also cause resonance in the drive circuit of the motor M1.

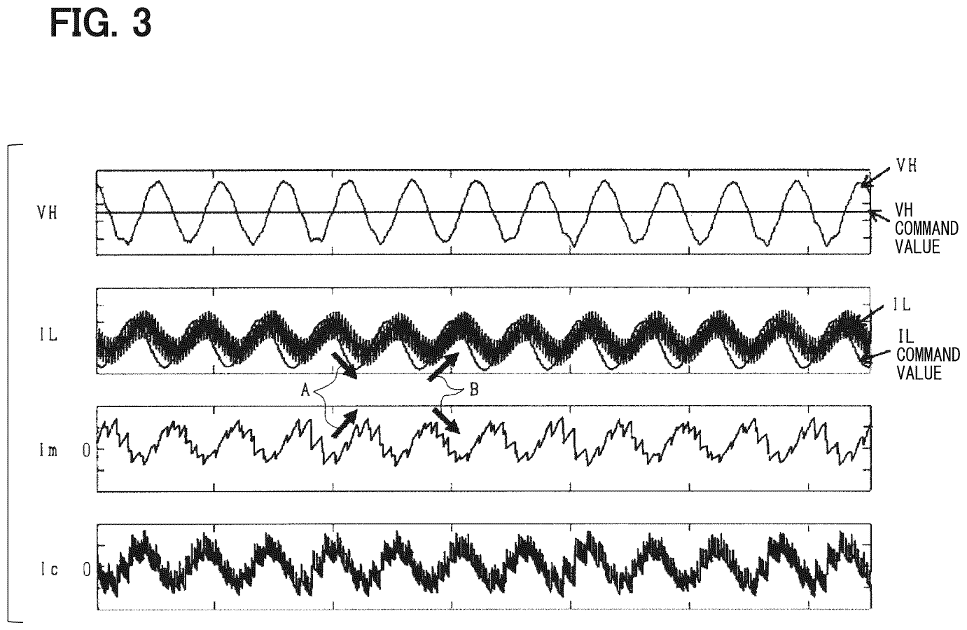

FIG. 3 is a graph showing the voltage VH, the supply current IL, the load current Im, and the capacitor current Ic when resonance occurs in a comparative example. As shown in FIG. 1, the voltage VH is the voltage across the smoothing capacitor C0; the supply current IL is the current supplied from the converter 12 to the smoothing capacitor C0 and the inverter 14; the load current Im is the current flowing to the inverter 14; and the capacitor current Ic is the current flowing to the smoothing capacitor C0.

Even if the VH command value is constant, the resonance occurs in the drive circuit due to the resonance characteristics during the square wave control of the inverter 14 to cause the load current Im to fluctuate. The IL command value is changed in order to suppress the fluctuation in the voltage VH due to the fluctuation in the load current Im. However, when the resonance occurs, the fluctuation in voltage VH cannot be suppressed.

The capacitor current Ic is a current obtained by subtracting the load current Im from the supply current IL (Ic=IL−Im). The voltage VH can be calculated based on the capacitance C of the smoothing capacitor C0 and the capacitor current Ic by the following formula.

$$VH = 1 / C \int Icdt$$

Therefore, it is possible to suppress the fluctuation of the voltage VH by suppressing the fluctuation of the capacitor current Ic from 0, that is, by suppressing the capacitor current Ic. In contrast, in FIG. 3, for example, with regard to the arrow A, while the load current Im increases, the supply current IL decreases and the capacitor current Ic decreases. With regard to the arrow B, the load current Im decreases while the supply current IL increases, and the capacitor current Ic increases. As a result, the capacitor current Ic fluctuates from 0, and thus the voltage VH fluctuates.

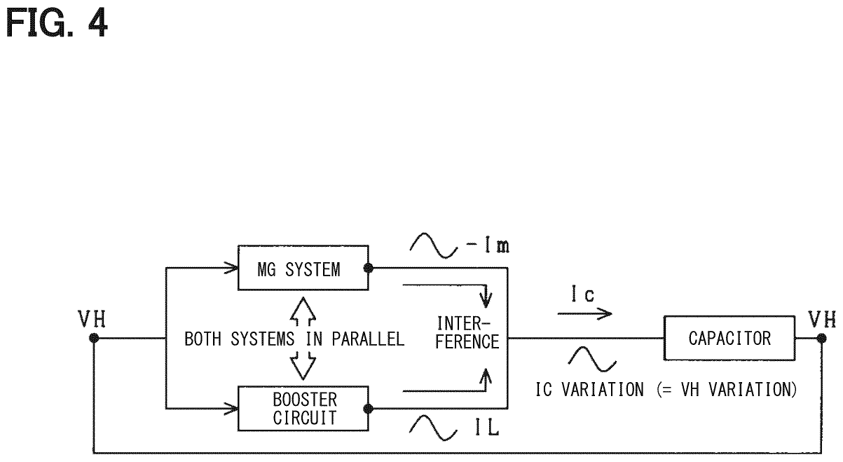

FIG. 4 is a schematic diagram showing the relationship of respective currents in the blocks of the motor drive system 10. The MG system is a block including the motor M1 and the inverter 14. The booster circuit is a block including the DC power supply B and the converter 12. The capacitor is the smoothing capacitor C0. The relationship of the respective currents in the blocks can be considered as currents being provided from the MG system and the booster circuit to the capacitor. In this case, the MG system and the booster circuit are connected in parallel to the capacitor, and the current (−Im) in the opposite direction to the load current Im and the supply current IL interfere with each other to cause the capacitor current Ic to fluctuate. As a result, the voltage VH fluctuates and continues to fluctuate (resonance occurs).

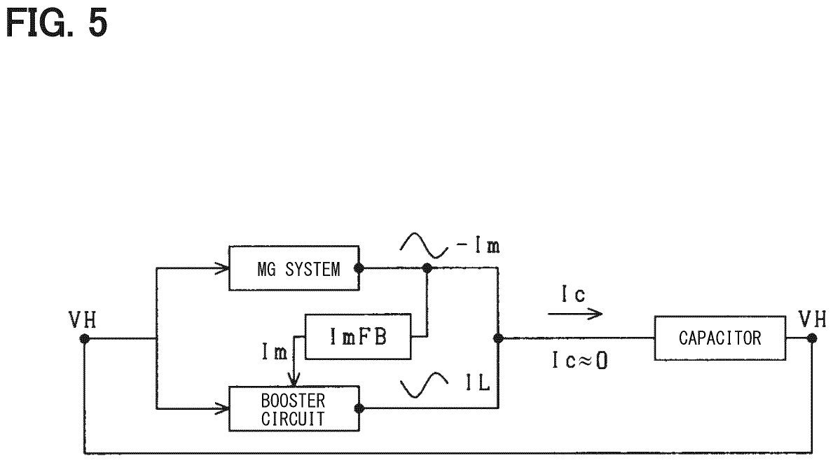

FIG. 5 is a schematic diagram showing a mode of suppressing the capacitor current Ic. If the supply current IL is controlled (ImFB) in accordance with the fluctuation in the load current Im so that the current (−Im) in the opposite direction to the load current Im and the supply current IL cancel each other out, the capacitor current Ic can be made to approach zero. That is, by controlling the supply current IL in accordance with the fluctuation in the load current Im so that IL−Im≈0 (IL≈Im), it is possible to make the capacitor current Ic≈0, thereby suppressing the fluctuation in the voltage VH.

Therefore, the controller 30 controls the supply current IL supplied from the converter 12 to the smoothing capacitor C0 and the inverter 14, according to the fluctuation in the load current Im flowing to the inverter 14 so as to suppress the capacitor current Ic flowing to the smoothing capacitor C0. The controller 30 brings the magnitude of the supply current IL closer to the magnitude of the load current Im so as to suppress the capacitor current Ic flowing to the smoothing capacitor C0. Furthermore, the controller 30 synchronizes the phase in which the supply current IL fluctuates with the phase in which the load current Im fluctuates so as to suppress the capacitor current Ic flowing to the smoothing capacitor C0.

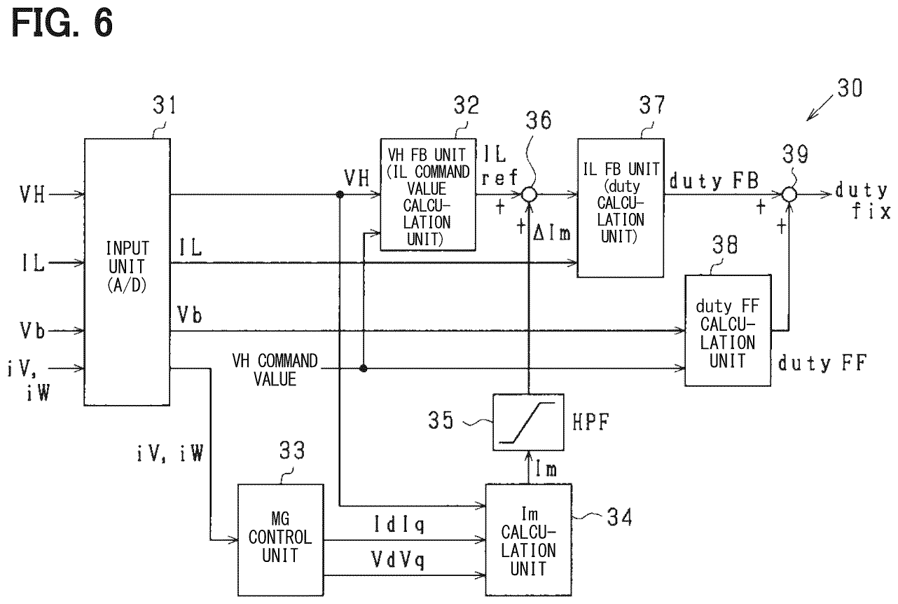

FIG. 6 is a block diagram showing the booster control by the controller 30. The controller 30 includes an input unit 31, a VHFB unit 32, an MG control unit 33, an Im calculation unit 34, a high-pass filter (HPF) 35, an adder 36, an ILFB unit 37, a duty FF calculation unit 38, and an adder 39.

The input unit 31 provides the voltage VH detected by the voltage sensor 22, the supply current IL detected by the current sensor 26, the power supply voltage Vb detected by the voltage sensor 20, and the V-phase current iv and W-phase current iw detected by the current sensor 24 in order to execute A/D conversion.

The VHFB unit 32 receives the voltage VH and the VH command value, and calculates a supply current command value ILref so as to bring the voltage VH closer to the VH command value, for example, by PI control (feedback control). The VH command value is set by a voltage VH setting unit of the controller 30 based on, for example, the driving state of the motor M1.

The MG control unit 33 calculates a d-axis voltage command value Vd and a q-axis voltage command value Vq by vector control of a dq-axis model. The MG control unit 33 also receives a V-phase current iv and a W-phase current iw, and calculates a d-axis current Id and a q-axis current Iq by three-phase to two-phase conversion.

The Im calculation unit 34 (load current estimation unit) provides the voltage VH, the d-axis current Id, the q-axis current Iq, the d-axis voltage command value Vd, and the q-axis voltage command value Vq (driving state of the motor M1), and calculates (estimates) the load current Im based on these values. The Im calculation unit 34 calculates the load current Im by the following formula.

$$I m = ( Id \times Vd + Iq \times Vq ) / VH$$

The HPF 35 (fluctuation extracting unit) receives the load current Im and passes high frequency components of the load current Im to extract the fluctuation ΔIm of the load current Im.

The adder 36 adds the fluctuation ΔIm to the supply current command value ILref to correct the supply current command value ILref.

The ILFB unit 37 receives the supply current IL and the corrected supply current command value ILref, and calculates dutyFB by, for example, the PI control (feedback control) so as to bring the supply current IL closer to the corrected supply current command value ILref. The dutyFB is a feedback control component of the duty value that controls the opening and closing of the switching elements Q1 and Q2.

The duty FF calculation unit 38 receives the power supply voltage Vb and the VH command value, predicts the voltage VH by feedforward control, and calculates duty FF so as to bring the voltage VH closer to the VH command value. The dutyFF is a feedforward control component of the duty value that controls the opening and closing of the switching elements Q1 and Q2.

An adder 39 adds dutyFB and dutyFF to calculate dutyfix as the control signals S1 and S2.

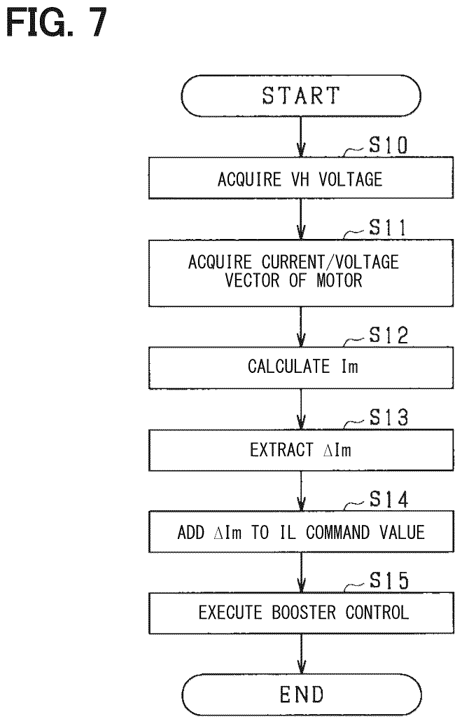

FIG. 7 is a flowchart illustrating a procedure of the booster control. This series of processes is repeatedly executed by the controller 30 at a predetermined cycle.

First, the voltage VH detected by the voltage sensor 22 is obtained in S10. The d-axis current Id, the q-axis current Iq, the d-axis voltage command value Vd, and the q-axis voltage command value Vq calculated by the MG control unit 33 are acquired in S11. The load current Im is calculated based on the voltage VH, the d-axis current Id, the q-axis current Iq, the d-axis voltage command value Vd, and the q-axis voltage command value Vq in S12. Fluctuation ΔIm is extracted from the load current Im in S13. The supply current command value ILref is corrected by adding the fluctuation ΔIm to the supply current command value ILref in S14. The dutyfix is calculated by adding the dutyFB calculated based on the corrected supply current command value ILref and the dutyFF calculated based on the power supply voltage Vb and the VH command value, and the switching elements Q1, Q2 are controlled based on the dutyfix in S15. Then, the series of processing described above is terminated in END.

The processing of S10 to S12 correspond to the processing executed by the Im calculation unit 34; the processing of S13 corresponds to the processing performed by the HPF 35; the process of S14 corresponds to the processing performed by the adder 36; and the processing of S15 corresponds to the processing performed by the ILFB unit 37, the duty FF calculation unit 38, and the adder 39.

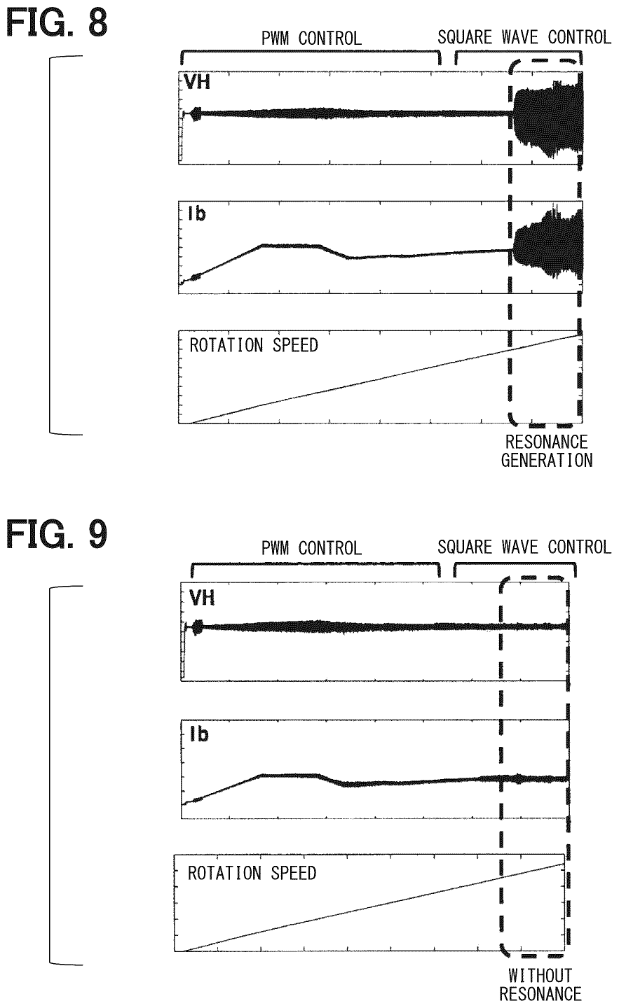

FIG. 8 is a graph showing the relationship between the rotation speed of the motor M1, the battery current Ib, and the voltage VH in a comparative example. When the rotation speed of the motor M1 is on a side lower than a predetermined inverter control boundary line, the PWM control is being executed. In this case, the battery current Ib and voltage VH are stable, and no resonance occurs in the drive circuit of the motor M1. On the other hand, when the rotation speed of the motor M1 is on a side higher than the predetermined inverter control boundary line, the square wave control is executed. In this case, the battery current Ib and voltage VH fluctuate greatly to cause resonance in the drive circuit of the motor M1.

FIG. 9 is a graph showing the relationship among the rotation speed of the motor M1, the battery current Ib, and the voltage VH in the present embodiment. When the rotation speed of the motor M1 is on a side lower than a predetermined inverter control boundary line, the PWM control is being executed. In this case, the battery current Ib and voltage VH are stable, and no resonance occurs in the drive circuit of the motor M1. On the other hand, when the rotation speed of the motor M1 is on a side higher than the predetermined inverter control boundary line, the square wave control is executed. In this case, the battery current Ib and voltage VH are stable, and no resonance occurs in the drive circuit of the motor M1.

The present embodiment described above in detail has the following advantages.

According to the present disclosure, the voltage fluctuation of the smoothing capacitor C0 due to resonance may be caused by the capacitor current Ic flowing to the smoothing capacitor C0. The capacitor current Ic is the current acquired by subtracting the load current Im from the supply current IL (Ic=IL−Im). Therefore, if the capacitor current Ic can be suppressed (closer to zero), the voltage fluctuation of the smoothing capacitor C0 due to resonance can be suppressed. The controller 30 controls the supply current IL in response to the fluctuation ΔIm of the load current Im so as to suppress capacitor current Ic. Therefore, the voltage fluctuation of the smoothing capacitor C0 due to resonance can be suppressed, and the occurrence of resonance in the drive circuit in the motor drive system 10 can be suppressed. As a result, heat generation from the DC power supply B and damage to each element can be suppressed.

The controller 30 includes an Im calculation unit 34 that estimates the load current Im based on the driving state (Id, Iq, Vd, Vq) of the motor M1. With this configuration, the Im calculation unit 34 can estimate the load current Im from the driving state of the motor M1 grasped by the controller 30, and there is no need to add new components such as a current sensor to detect the load current Im.

The HPF 35 can extract the fluctuation ΔIm of the load current Im from the load current Im estimated by the Im calculation unit 34.

The controller 30 brings the magnitude of the supply current IL closer to the magnitude of the load current Im so as to suppress the capacitor current Ic flowing to the smoothing capacitor C0. According to this configuration, it is possible to suppress the capacitor current Ic flowing to the smoothing capacitor C0 by controlling the magnitude of the supply current IL.

The controller 30 synchronizes the phase in which the supply current IL fluctuates with the phase in which the load current Im fluctuates so as to suppress the capacitor current Ic flowing to the smoothing capacitor C0. According to this configuration, it is possible to suppress the capacitor current Ic flowing to the smoothing capacitor C0 by controlling the phase in which the supply current IL fluctuates.

Since the capacitor current Ic can be suppressed, even if the smoothing capacitor C0 is made smaller in capacity, the voltage fluctuation of the smoothing capacitor C0 can be suppressed.

The embodiment described above may be modified in the following manners. Parts same as the parts of the above embodiment are designated by the same reference signs as the above embodiment to omit redundant description.

A current sensor may be provided in the positive line 47 between the inverter 14 and the connection node between the smoothing capacitor C0 and the positive line 47, and the load current Im may be detected by the current sensor.

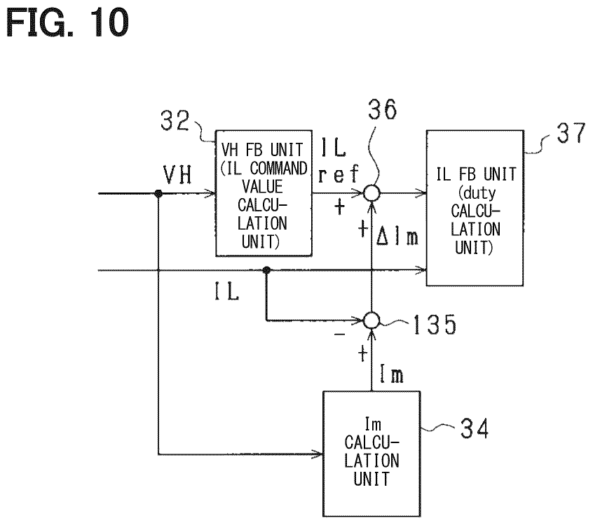

The relationship Ic=IL−Im can be expressed as Im−IL=−Ic. Here, −Ic represents the fluctuation ΔIm of the load current Im (−Ic=ΔIm). As shown in FIG. 10, the fluctuation ΔIm can be calculated from the equation ΔIm=Im−IL by subtracting the supply current IL from the load current Im using a subtractor 135.

For example, the fluctuation ΔIm of the load current Im can be extracted (calculated) by applying a Fourier series expansion to the load current Im.

If there are harmonic components in the d-axis current Id and q-axis current Iq, then the load current Im, which is calculated based on the d-axis current Id and q-axis current Iq, will also be affected by harmonic components. Moreover, the supply current IL, which is controlled according to the variation ΔIm of the load current Im, will also be influenced by harmonic components. As a result, the pulsating component (ripple) contained in the supply current IL may increase.

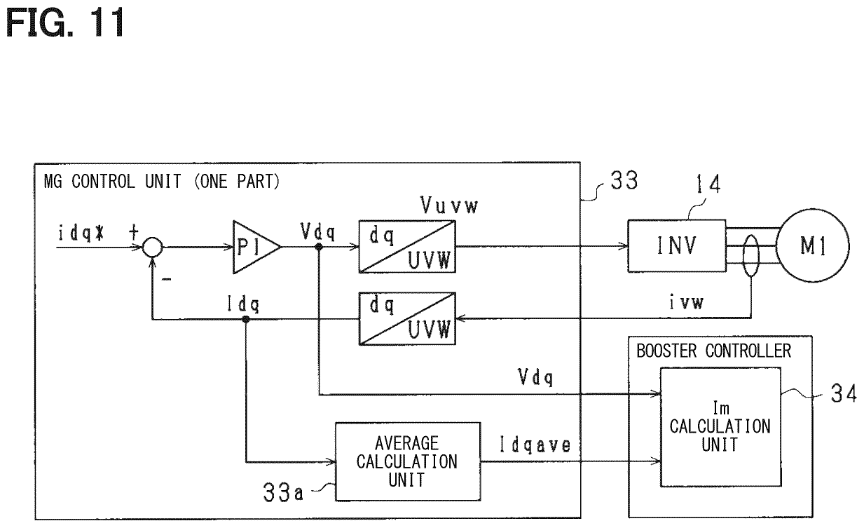

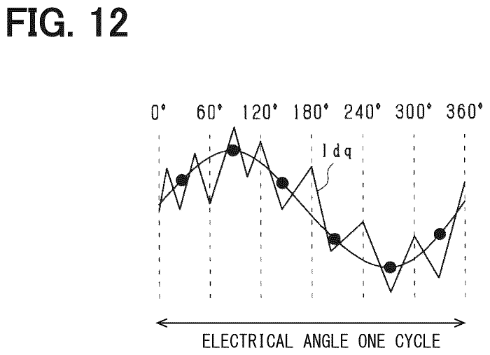

As shown in FIG. 11, the MG control unit 33 of the controller 30 may be provided with an average calculation unit 33a (component removal unit) that removes harmonic components from the detected d-axis current Id and q-axis current Iq (Idq), and ultimately from the load current Im estimated by the Im calculation unit 34. For example, as shown in FIG. 12, the average calculation unit 33a removes harmonic components by calculating a 60° moving average of the d-axis current Id and the q-axis current Iq in one electrical angle cycle. According to this configuration, it is possible to remove harmonic components from the load current Im, and to suppress an increase in ripples in the supply current IL.

In addition, by passing the d-axis current Id and the q-axis current Iq through a low-pass filter (LPF) or by applying the Fourier series expansion to the d-axis current Id and the q-axis current Iq, it is possible to remove harmonic components from the d-axis current Id and the q-axis current Iq, and ultimately from the load current Im.

The motor drive system and the technique according to the present disclosure may be achieved by a dedicated computer provided by constituting a processor and a memory programmed to execute one or more functions embodied by a computer program. One or more functions correspond to one or more commands. The computer program corresponds to a motor drive program. The motor drive system 10 and the method thereof described in the present disclosure may be implemented by a dedicated computer including a processor implemented by one or more dedicated hardware logic circuits. The motor drive system 10 and the technique according to the present disclosure may be achieved using one or more dedicated computers constituted by a combination of the processor and the memory programmed to execute one or more functions and the processor with one or more hardware logic circuits. In addition, the computer program may be stored in a computer-readable non-transition tangible recording medium as an instruction to be executed by a computer.

Although the present disclosure has been described in accordance with the embodiments, it is understood that the present disclosure is not limited to such examples or structures. The present disclosure encompasses various modifications and variations within the scope of equivalents. In addition, while the various combinations and configurations, which are preferred, other combinations and configurations, including more, less or only a single element, are also within the spirit and scope of the present disclosure.

What is claimed is:

1. A motor drive system comprising:
a DC power supply;
a motor;
a drive circuit including
a converter having a resonance circuit that resonates in a predetermined resonance frequency band, the converter configured to convert a voltage of the DC power supply,
an inverter configured to execute power conversion between the converter and the motor, and
a smoothing capacitor being connected between the converter and the inverter in parallel; and
a controller configured to control the drive circuit to suppress a capacitor current flowing to the smoothing capacitor by controlling a supply current being supplied from the converter to the smoothing capacitor and the inverter, according to fluctuation in a load current flowing to the inverter.

2. The motor drive system according to claim 1,
wherein the controller includes a load current estimation unit configured to estimate the load current based on a driving state of the motor.

3. The motor drive system according to claim 2,
wherein the controller includes a fluctuation extracting unit configured to extract a magnitude of the fluctuation from the load current being estimated by the load current estimation unit.

4. The motor drive system according to claim 2,
wherein the controller includes a component removal unit configured to remove a harmonic component from the load current being estimated by the load current estimation unit.

5. The motor drive system according to claim 1,
wherein the controller is configured to control the drive circuit to suppress the capacitor current flowing to the smoothing capacitor by controlling a magnitude of the supply current to be closer to a magnitude of the load current.

6. The motor drive system according to claim 1, wherein:
the controller is configured to control the drive circuit to suppress the capacitor current flowing to the smoothing capacitor by synchronizing a first phase of the motor with a second phase of the motor; and
the first phase is a phase in which the supply current fluctuates, and the second phase is a phase in which the load current fluctuates.

7. A non-transitory computer readable medium storing a computer program adapted to a motor drive system, the computer program comprising instructions configured to, when executed by a controller, cause the controller to suppress a capacitor current flowing to a smoothing capacitor by controlling a supply current being supplied from a converter to the smoothing capacitor and an inverter according to fluctuation of a load current flowing to the inverter in the motor drive system, wherein
the smoothing capacitor is connected between the converter and the inverter in parallel.
